(19) United States
(12) Patent Application Publication
(10) Pub. No.: US 2013/0156951 A1
(43) Pub. Date: Jun. 20, 2013

(54) METHOD FOR MANUFACTURING SILICON OXIDE NANO WIRES

(71) Applicant: SAMSUNG ELECTRO-MECHANICS CO., LTD., Gyeonggi-do (KR)

(72) Inventors: Seon Hee JANG, Chungcheongnam-do (KR); Young Il LEE, Gyeonggi-do (KR); Su Hwan CHO, Seoul (KR); Dong Hoon KIM, Gyeonggi-do (KR); Jung Wook SEO, Gyeonggi-do (KR)

(73) Assignee: SAMSUNG ELECTRO-MECHANICS CO., LTD., Gyeonggi-do (KR)

(21) Appl. No.: 13/709,502

(22) Filed: Dec. 10, 2012

(30) Foreign Application Priority Data
Dec. 19, 2011 (KR) 10-2011-0137428

(51) Int. Cl. B05D 3/04

(52) U.S. Cl. CPC B05D 3/0453; B82Y 30/00
USPC 427/256; 427/377; 977/762

(57) ABSTRACT

Disclosed herein is a method for manufacturing silicon oxide nano wires, the method including: a metal nano particle applying step of applying metal nano particles to a silicon wafer; and a heat treatment step of performing heat treatment under an atmosphere of reactive gas including hydrogen gas. Therefore, the silicon oxide nano wires may be manufactured by a simple process and a separate silicon source needs not to be injected, such that a manufacturing cost may be decreased and manufacturing efficiency may be improved, as compared with methods according to the related art.

### CROSS REFERENCE(S) TO RELATED APPLICATIONS

This application claims the benefit under 35 U.S.C. Section 119 of Korean Patent Application Serial No. 10-2011-0137428, entitled “Method for Manufacturing Silicon Oxide Nano Wires” filed on Dec. 19, 2011, which is hereby incorporated by reference in its entirety into this application.

### BACKGROUND OF THE INVENTION

1. Technical Field

The present invention relates to a method for manufacturing silicon oxide nano wires.

2. Description of the Related Art

Since a carbon nano tube was initially developed in 1991, various types of nano tubes such as a one-dimensional nano structure, tube, wire, bar, belt, and the like, have been developed.

Since these nano structures reveal physical, optical, and electrical characteristics different from those in a bulk state, research into applying the nano structures to various kinds of nano scale devices has been continuously conducted.

As a result of the continuous research, nano structures could be obtained from an inorganic material such as a single component semiconductor (Si, Ge, and B), a group III-V compound semiconductor (GaN, GaAs, GaP, InP, and InAs), a group II-VI compound semiconductor (ZnS, ZnSe, CdS, and CdSe), an oxide (ZnO, MgO, and SiO2), and the like.

Among them, a nano structure using silicon was found to be useful in view of optical characteristics. Therefore, research into applying the nano structure using the silicon to devices such as a bio sensor, a nano based optical device, a nano based optical sensor, and the like, has been continuously conducted.

Meanwhile, several methods regarding synthesis of a silicon oxide (SiOx) nano wire (SiOxNW) have been reported.

The silicon oxide nano wire may be generally manufactured by a method such as a thermal evaporation method, a chemical vapor deposition (CVD), a laser ablation method, or the like.

However, these methods according to the related art require oxygen during a period in which the silicon oxide nano wire is formed or require a starting material for forming a silicon oxide. Further, these methods according to the related art require a separate silicon source and a complicated deposition process.

### RELATED ART DOCUMENT

### Patent Document

(Patent Document 1) Korean Patent Laid-Open Publication No. 10-2009-0087467

(Patent Document 2) Korean Patent Laid-Open Publication No. 10-2010-0007255

### SUMMARY OF THE INVENTION

An object of the present invention is to provide a method for manufacturing silicon oxide nano wires capable of manufacturing the silicon oxide nano wires by applying metal nano particles to a silicon wafer and then performing heat treatment on the silicon wafer to which the metal nano particles are applied.

According to an exemplary embodiment of the present invention, there is provided a method for manufacturing silicon oxide nano wires, the method including: a metal nano particle applying step of applying metal nano particles to a silicon wafer; and a heat treatment step of performing heat treatment under an atmosphere of reactive gas including hydrogen gas.

The metal nano particles may be nickel nano particles.

The heat treatment step may be performed under the atmosphere of the reactive gas further including nitrogen.

The hydrogen gas may be included in the reactive gas in a range of 1 to 99% of the entire volume of the reactive gas based on a standard state.

The metal nano particle applying step may be performed by any one of an inkjet method, a screen printing method, and a gravure method.

The heat treatment step may be performed at a temperature of 900 to 1100° C.

The heat treatment step may be performed for 10 to 60 minutes.

The nickel nano wire may have a diameter of 1 to 900 nm.

The metal nano particle applying step may be performed by applying the nickel nano particles to the silicon wafer in the state in which they are mixed with a dispersing agent, a binder, and a solvent.

In the metal nano particle applying step, the nickel nano particles, a dispersing agent, a binder, and a solvent may be applied to a surface of the silicon wafer at a thickness of 5 to 15 μm in the state in which they are mixed with one another.

### BRIEF DESCRIPTION OF THE DRAWINGS

FIG. 1 is a flow chart schematically showing a method for manufacturing silicon oxide nano wires according to an exemplary embodiment of the present invention;

FIG. 2 is a field emission-scanning electron microscope (FE-SEM) image of nickel nano particles;

FIG. 3 is an FE-SEM image of a silicon wafer on which the silicon oxide nano wires according to the exemplary embodiment of the present invention are formed;

FIGS. 4A and 4B are graphs obtained by analyzing each of a silicon oxide nano wire region and a Ni agglomeration region using an energy dispersive spectroscopy (EDS);

FIGS. 5A to 5C are EL-SEM images of the silicon oxide nano wires manufactured according to the exemplary embodiment of the present invention;

FIGS. 6A and 6B are graphs showing a result obtained by analyzing each of region 1 and region 2 of FIG. 5C using the EDS; and

FIG. 7 is a graph showing PL intensity of the silicon oxide nano wires manufactured under a changed condition for a heat treatment process according to the exemplary embodiment of the present invention.

### DESCRIPTION OF THE PREFERRED EMBODIMENTS

Various advantages and features of the present invention and methods accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art. Like reference numerals throughout the description denote like elements.

Terms used in the present specification are for explaining exemplary embodiments rather than limiting the present invention. Unless explicitly described to the contrary, a singular form includes a plural form in the present specification. The word “comprise” and variations such as “comprises” or “comprising,” will be understood to imply the inclusion of stated constituents, steps, operations and/or elements but not the exclusion of any other constituents, steps, operations and/or elements.

Hereinafter, a configuration and an acting effect of exemplary embodiments of the present invention will be described in more detail with reference to the accompanying drawings.

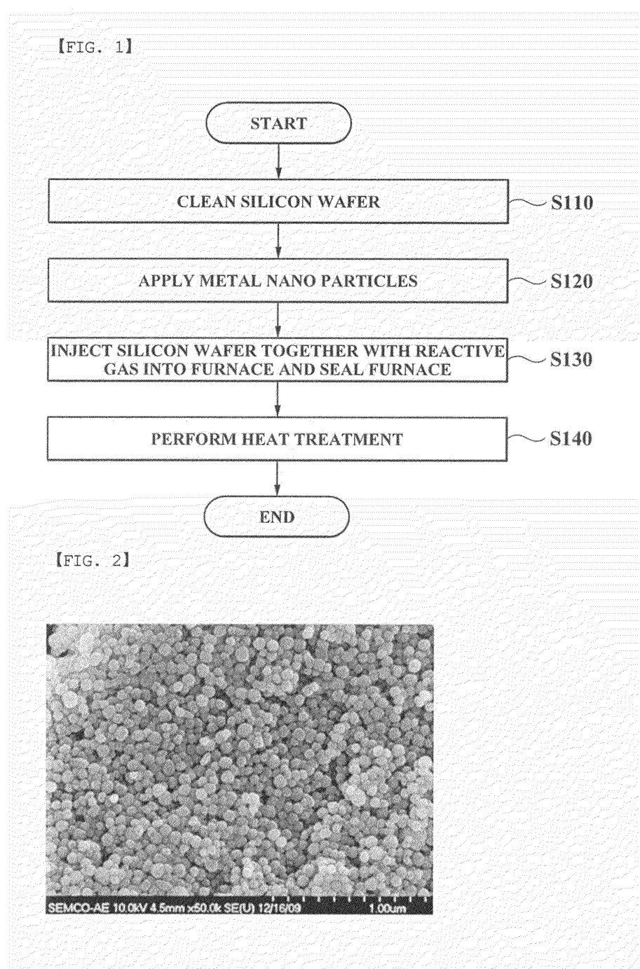

FIG. 1 is a flow chart schematically showing a method for manufacturing silicon oxide nano wires according to an exemplary embodiment of the present invention.

Referring to FIG. 1, the method for manufacturing silicon oxide nano wires according to the exemplary embodiment of the present invention may include a metal nano particle applying step (S120) and a heat treatment step (S140).

Here, before, the metal nano particle applying step, a step (S110) of cleaning a silicon wafer may be first performed.

In the metal nano particle applying step, metal nano particles are applied to a surface of the silicon wafer (S120).

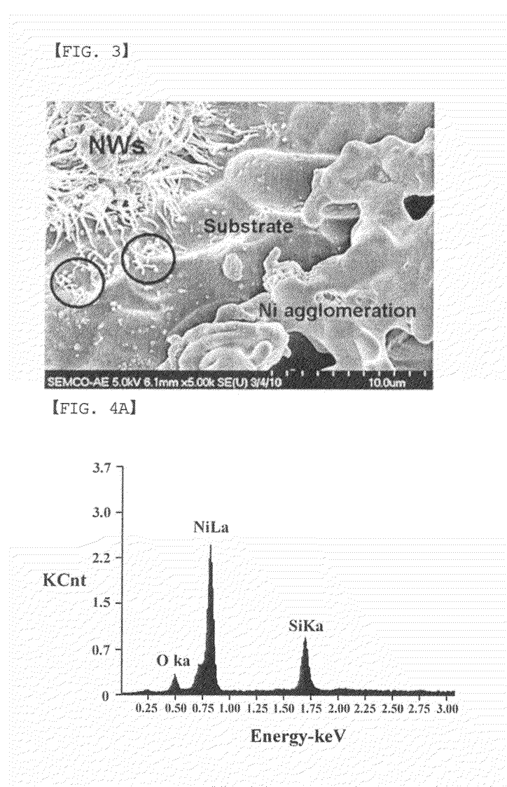

FIG. 2 is a field emission-scanning electron microscope (FE-SEM) image of nickel nano particles. As shown in FIG. 2, nickel (Ni) nano particles may be used as the metal nano particles and have a diameter of 1 to 900 nm. The diameter of the nickel nano particle may be changed to adjust a diameter of the silicon oxide nano wire.

Meanwhile, the metal nano particles may be applied to the surface of the silicon wafer in a form in which they are mixed with a dispersing agent, a binder, and a solvent.

In addition, the metal nano particles may be applied to the silicon wafer by a method such as an inkjet method, a screen printing method, a gravure method, or the like, and have a thickness of about 5 to 15 μm.

Next, the heat treatment step is performed under an atmosphere of reactive gas including hydrogen gas (S140). In this case, the silicon wafer to which metal nano particles are applied is put in a furnace, the reactive gas including the hydrogen gas is injected into the furnace and the furnace is sealed (S130), and the heat treatment is then performed on the silicon wafer to which metal nano particles are applied (S140).

Meanwhile, the reactive gas may further include nitrogen gas, and a ratio of volume of the hydrogen gas to total volume of the reactive gas in a standard state may be in a range of 1 to 99%.

Here, the hydrogen gas serves to assist in a reducing action of the nickel nano particle, and should be necessarily included in the reactive gas in the heat treatment process since growth of the silicon oxide nano wire is not made in the state in which there is not hydrogen gas.

In addition, when the entire reactive gas is the hydrogen gas, grain growth of the metal nano particle, particularly, the nickel nano particle is generated. Therefore, a content percentage of the hydrogen gas in the reactive gas should be 99% or less.

Further, the heat treatment may be performed in a temperature range of 900 to 1100° C. for 10 to 60 minutes.

An eutectic point between silicon and nickel is about 964° C. However, since the nickel nano particle has a melting point lower than a bulk particle, Si—Ni alloys are formed at a temperature of about 900° C., such that growth of the silicon oxide nano wires may start.

Here, the heat treatment temperature and time are changed in the above-mentioned range, such that a thickness, a length, a density, and the like, of the silicon oxide nano wires may be determined.

In addition, the silicon oxide nano wires starts to be grown using the Si—Ni alloys as a seed. In this case, the growth of the silicon oxide nano wires starts after the heat treatment is performed at a temperature of a temperature of 900 to 1100° C. for 10 minutes or more.

Further, when the heat treatment is performed for 60 minutes or more, since the silicon oxide nano wires are excessively grown, it is not preferable in view of yield to continue the heat treatment.

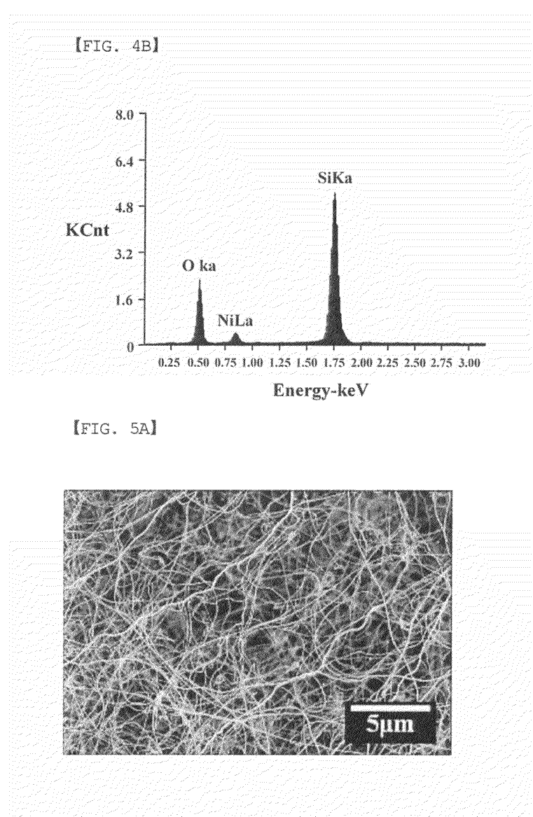

FIG. 3 is an FE-SEM image of a silicon wafer on which the silicon oxide nano wires according to the exemplary embodiment of the present invention are foamed; and FIGS. 4A and 4B are graphs obtained by analyzing each of a silicon oxide nano wire region and a Ni agglomeration region using an energy dispersive spectroscopy (EDS).

Referring to FIG. 3, a region in which the heat treatment is performed under the atmosphere of the hydrogen gas, such that the nickel nano particles are agglomerated while being sintered is denoted by “Ni agglomeration”, and a region in which a nano wire bundle is formed and agglomeration/grain growth of particles are shown is denoted by “NWs” at the other side.

FIG. 4A is a graph showing an EDS analyzing result of the “Ni agglomeration” region, and FIG. 4B is a graph showing an EDS analyzing result of the “NWs” region.

Referring to FIGS. 4A and 4B, in the Ni agglomeration” region, high concentration nickel has been observed, and silicon (Si) due to the silicon wafer and an oxygen (O) peak have also been observed.

Further, in the “NWs region” a large amount of silicon (Si) has been observed, a relatively small amount of oxygen (O) has been observed, and a significantly small amount of nickel (Ni) has been observed.

In the method for manufacturing silicon oxide nano wires according to the exemplary embodiment of the present invention, silicon (Si) is not separately injected at the time of heat treatment, but the silicon wafer serves as a supply source of the silicon in a process of forming the silicon oxide nano wires.

Further, an oxide (O) forming the silicon oxide nano wires may be included in the reactive gas. Meanwhile, even in the case in which the oxide is separately included in the reactive gas, the oxide may be supplied from a natural oxide film formed on the surface of the silicon wafer.

In addition, it seems that the silicon wafer to which the nickel nano particles are applied is heated under the atmosphere of the reactive gas including the hydrogen gas, such that liquid phase Ni—Si alloy droplets are formed, and these Ni—Si alloy droplets become growth seeds, such that the growth of the silicon nano wires starts.

Further, it seems that as the Ni—Si alloy droplets are saturated, the silicon and the oxide react to each other while being continuously dissolved in the Ni—Si alloy droplets, such that the growth of the silicon oxide nano wires are continued.

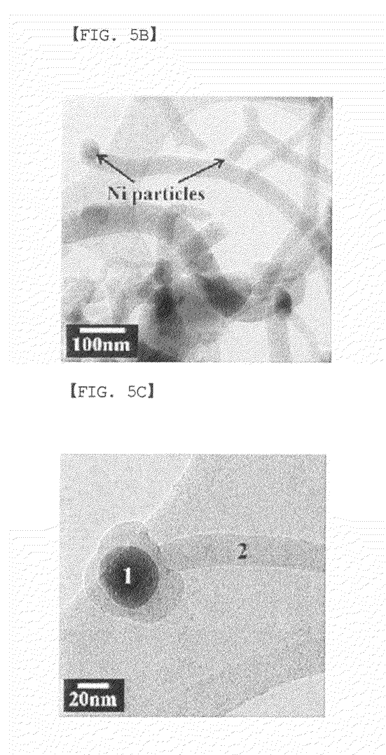

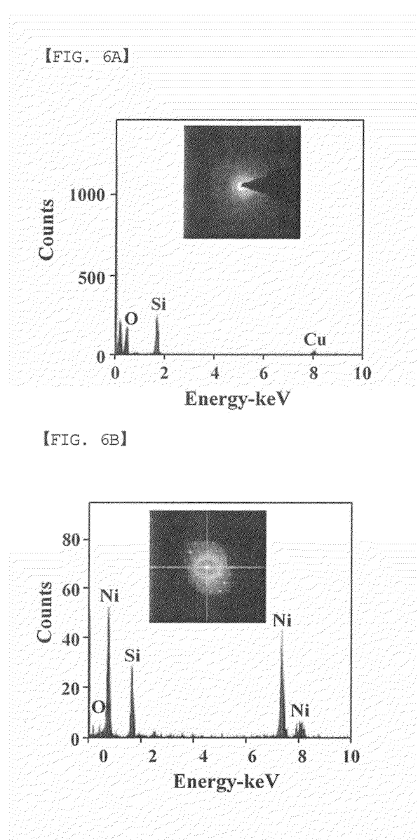

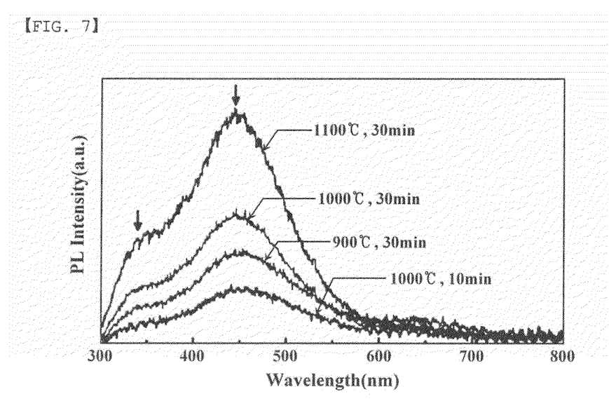

FIGS. 5A to 5C are FE-SEM images of the silicon oxide nano wires manufactured according to the exemplary embodiment of the present invention; and FIGS. 6A and 6B are graphs showing a result obtained by analyzing each of region 1 and region 2 of FIG. 5C using the EDS.

Referring to FIGS. 5A to 6B, it could be confirmed that the silicon oxide nano wires are amorphously grown from the nickel nano particles, which are seeds.

Further, in consideration of EDS analyzing results of region 1 and region 2 of the silicon oxide nano wire, is seems that a ratio of Si:O of the silicon oxide nano wire is about 1:2.18.

Further, it was confirmed that the silicon oxide nano wire manufactured by the method for manufacturing silicon oxide nano wires according to the exemplary embodiment of the present invention has a length of about 1 to 10 μm and a width of about 100 to 200 nm.

FIG. 7 is a graph showing PL intensity of the silicon oxide nano wires manufactured under a changed condition for a heat treatment process according to the exemplary embodiment of the present invention.

Referring to FIG. 7, it could be confirmed that as a heat treatment temperature and a heat treatment time increase, the PL intensity increases, and light having a wavelength of about 450 nm is generated in all cases.

According to the exemplary embodiment of the present invention configured as described above, the silicon oxide nano wires may be manufactured by a simple process of applying the metal nano particles to the silicon wafer and then performing the heat treatment on the silicon wafer to which the metal nano particles are applied and a separate silicon source needs not to be injected, such that a manufacturing cost may be decreased and manufacturing efficiency may be improved, as compared with methods according to the related art.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A method for manufacturing silicon oxide nano wires, the method comprising:
a metal nano particle applying step of applying metal nano particles to a silicon wafer; and
a heat treatment step of performing heat treatment under an atmosphere of reactive gas including hydrogen gas.

2. The method according to claim 1, wherein the metal nano particles are nickel nano particles.

3. The method according to claim 1, wherein the heat treatment step is performed under the atmosphere of the reactive gas further including nitrogen.

4. The method according to claim 3, wherein the hydrogen gas is included in the reactive gas in a range of 1 to 99% of the entire volume of the reactive gas based on a standard state.

5. The method according to claim 1, wherein the metal nano particle applying step is performed by any one of an inkjet method, a screen printing method, and a gravure method.

6. The method according to claim 1, wherein the heat treatment step is performed at a temperature of 900 to 1100° C.

7. The method according to claim 1, wherein the heat treatment step is performed for 10 to 60 minutes.

8. The method according to claim 2, wherein the nickel nano wire has a diameter of 1 to 900 nm.

9. The method according to claim 8, wherein the metal nano particle applying step is performed by applying the nickel nano particles to the silicon wafer in the state in which they are mixed with a dispersing agent, a binder, and a solvent.

10. The method according to claim 8, wherein in the metal nano particle applying step, the nickel nano particles, a dispersing agent, a binder, and a solvent are applied to a surface of the silicon wafer at a thickness of 5 to 15 μm in the state in which they are mixed with one another.
